(19) United States
(12) Patent Application Publication
(10) Pub. No.: US 2012/0006283 A1
(43) Pub. Date: Jan. 12, 2012

(54) ANIMAL HANDLING STATION

(76) Inventor: Andrew S. Katz, Beverly, MA (US)

(21) Appl. No.: 12/833,602

(22) Filed: Jul. 9, 2010

(51) Int. Cl. A01K 29/00

(52) U.S. Cl. 119/753

(57) ABSTRACT

Exemplary embodiments provide an animal handling station configured for use in handling an animal. The handling station includes a work platform to support the animal, a lift mechanism that supports, lifts and lowers the work platform, and a handling arm that secures the head of the animal during a handling session. In an exemplary embodiment, the work platform is designed and configured in a dog-bone shaped outline.

### TECHNICAL FIELD

Exemplary embodiments relate generally to stations used in handling animals.

### SUMMARY

Exemplary embodiments provide an ergonomic work platform attachable to a base unit. The work platform and the base unit may be configured as an animal handling station, e.g., an animal grooming station, an animal bathing station, an animal examination station, an animal surgery station, and similar platforms for performing animal handling activities.

Exemplary embodiments also provide an ergonomic animal handling station configured for use in handling an animal. The handling station includes a work platform, a base unit coupled thereto to support the animal, and a handling arm with a handling loop that secures the animal during a handling session.

In an exemplary embodiment, the work platform of the handling station is designed and configured in substantially an ergonomic shape. In some embodiments, the ergonomic shape takes the form of a bone, for example, a dog bone. This particular structural shape provides functional and operational advantages over traditional work platform shapes, which tend to be uniformly rectangular, circular or oval. In the exemplary embodiment, an animal handler positioned adjacent to a narrower mid-portion of the dog-bone shaped work platform is able to position him/herself close to the center of the work platform. This configuration allows the animal handler better control of the animal during a handling session and reduces the risk of the animal handler straining his/her back or suffering another injury while working with the animal. In addition, the slim outline presented by the dog-bone shape compels the animal to reduce its movement and remain centered on the work platform. The slim outline of the dog-bone shaped work platform thus makes it more convenient to handle the animal and results in a more efficient handling session.

In an exemplary embodiment, an animal handling work platform is provided for supporting an animal. The work platform includes a first end portion having a first width (W₁) measured at a widest section of the first end portion. The work platform includes a second end portion having a second width (W₂) measured at a widest section of the second end portion. The work platform also includes a middle portion having a third width (W₃) disposed contiguously between the first and second end portions to form a planar surface. A side of the middle portion, the first end portion and the second end portion collectively define an animal handler positioning area. The animal handler positioning area is defined by a W₃:W₁ ratio of about 1:2 and a W₃:W₂ ratio of about 1:2 to allow an animal handler to be closer to an animal supported on the work platform.

In another exemplary embodiment, an animal handling work platform is provided for supporting an animal. The work platform includes a first end portion having a first width (W₁) and including first and second convex portions that are contiguous to each other. The work platform includes a second end portion having a second width (W₂) and including third and fourth convex portions that are contiguous to each other. The work platform also includes a middle portion disposed contiguously between the first and second end portions to form a planar surface. The middle portion has a rectangular shape and a third width (W₃), and includes first and second sides disposed parallel to each other and parallel to a longitudinal axis of the work platform. The first side of the middle portion, the first end portion and the second end portion collectively define an animal handler positioning area. The animal handler positioning area having a depth defined by a W₃:W₁ ratio of about 1:2 and a W₃:W₂ ratio of about 1:2. The first and second sides of the middle portion, the first and second convex portions of the first end portion, and the third and fourth convex portions of the second end portion are configured to create a dog-bone shaped outline.

### BRIEF DESCRIPTION OF THE DRAWINGS

The foregoing and other objects, aspects, features, and advantages of exemplary embodiments will become more apparent and may be better understood by referring to the following description taken in conjunction with the accompanying drawings, in which:

FIG. 1 illustrates a top plan view of an exemplary work platform configured in a dog-bone shape.

FIG. 2 illustrates a partial top plan view of an exemplary work platform in which the side walls of the mid-portion are configured to be curved.

FIGS. 3A and 3B illustrate partial top plan views of exemplary work platforms in which one side wall of the mid-portion is configured to be curved, and the other side wall of the mid-portion is configured to be straight.

FIG. 4 illustrates a partial top view of an exemplary work platform in which each of the side walls of the mid-portion is configured as a straight portion with a radial cutout.

FIG. 5 illustrates a partial top plan view of an exemplary work platform in which each of the end portions is configured to have a elliptical shape.

FIG. 6 illustrates a partial top plan view of an exemplary work platform in which each of the end portions is configured to have a rectangular shape.

FIG. 7 illustrates an exemplary handling station including the exemplary work platform of FIG. 1, in which the base unit employs an electric lift mechanism.

FIG. 8 illustrates a perspective view of another exemplary animal handling station including the exemplary work platform of FIG. 1, in which the base unit employs a hydraulic lift mechanism.

FIG. 9 illustrates a perspective view of another exemplary animal handling station including the exemplary work platform of FIG. 1, in which the base unit employs a set of folding legs.

### DETAILED DESCRIPTION

Exemplary embodiments provide an ergonomic work platform attachable to a base unit. The work platform and the base unit may be configured as an animal handling station, e.g., an animal grooming station, an animal bathing station, an animal examination station, an animal surgery station, and similar stations for performing animal handling activities.

Exemplary embodiments also provide an animal handling station configured for use in handling an animal. The handling station includes a work platform, a base unit coupled thereto to support the animal and a handling arm with a handling loop that secures the animal during a handling session. In some exemplary embodiments, the base unit is configured as a lift mechanism with an adjustable height that supports, lifts and lowers the work platform. In other exemplary embodiments, the base unit is configured as a stationary support with a fixed height that supports the work platform but does not adjust the height of the work platform, e.g., a support column, a set of legs, and similar support structures with a fixed height.

An animal handling work surface, as used herein, is a work surface on which an animal is supported during a handling session. The animal may be any type of animal including, but not limited to, domestic animals such as cats and dogs.

Animal handling, as used herein, may include, but is not limited to, animal grooming, animal bathing, animal medical examination, animal surgical procedures, animal feeding, and similar animal handling activities. An animal handling session may include, but is not limited to, animal grooming, animal bathing, animal medical examination, animal surgical procedures, animal feeding, or any combination of such activities.

An animal handler, as used herein, is a person who performs an animal handling activity, e.g., a groomer, a veterinarian, a veterinarian technician, a person charged with feeding or bathing the animal, and persons performing similar animal handling activities.

The term “planar” is used herein, in a broad lay sense, to mean exactly planar or approximately planar within some tolerance from the exactly planar.

The term “concave” is used herein, in a broad lay sense, to mean exactly concave or approximately concave within some tolerance from the exactly concave.

The term “convex” is used herein, in a broad lay sense, to mean exactly convex or approximately convex within some tolerance from the exactly convex.

The term “elliptical” is used herein, in a broad lay sense, to mean exactly elliptical or approximately elliptical within some tolerance from the exactly elliptical.

The term “rectangular” is used herein, in a broad lay sense, to mean exactly rectangular or approximately rectangular within some tolerance from the exactly rectangular.

The term “parallel” is used herein, in a broad lay sense, to mean exactly parallel or approximately parallel within some tolerance from the exactly parallel.

The term “straight” is used herein, in a broad lay sense, to mean exactly straight or approximately straight within some tolerance from the exactly straight.

The term “equal” is used herein, in a broad lay sense, to mean exactly equal or approximately equal within some tolerance.

The term “adjacent” is used herein, in a broad lay sense, to mean immediately adjacent or approximately adjacent within some tolerance.

The term “dog-bone shape” is used herein, in a broad lay sense, to mean an exact dog-bone shape or an approximate dog-bone shape within some tolerance.

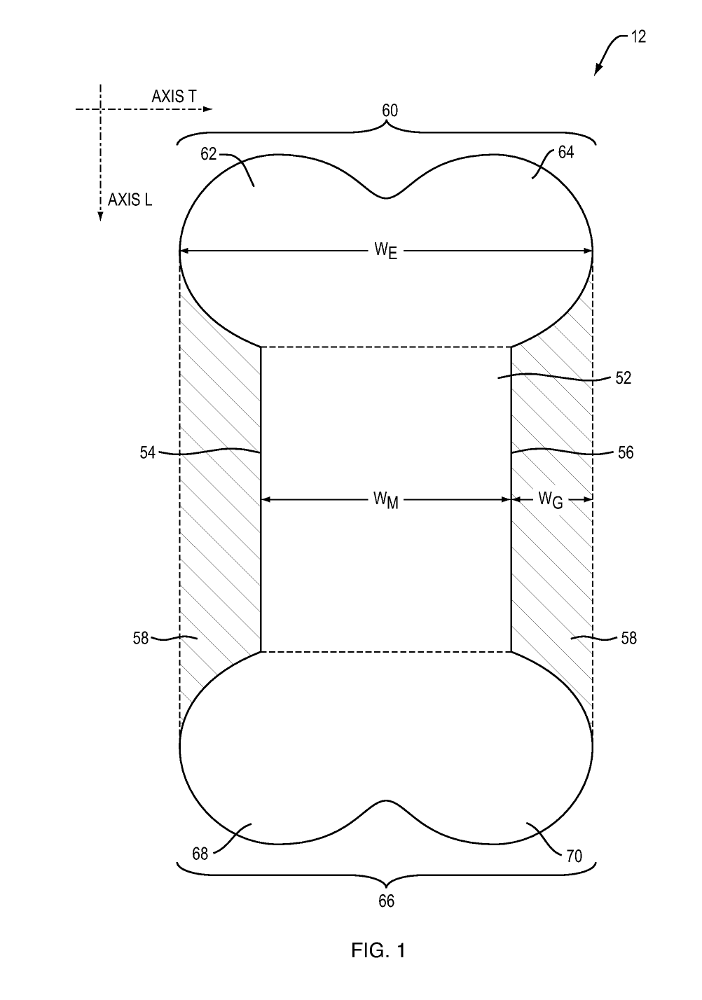

FIG. 1 illustrates a top plan view of an exemplary work platform 12 configured to support an animal during a handling session. FIG. 1 indicates a longitudinal axis L that runs substantially along the length of the work platform 12, and a traverse axis T that runs perpendicular to the longitudinal axis L. The work platform 12 includes a mid-portion 52 disposed contiguously between a first end-portion 60 and a second end-portion 66 along the longitudinal axis L. The mid-portion 52, the first end-portion 60 and the second end-portion 66 cooperatively form a planar surface for supporting the animal. The length of the work platform 12 measured relative to the longitudinal axis L may range from about 15 inches to about 100 inches.

The mid-portion 52 of the work platform 12 may be configured to have various shapes. In an exemplary embodiment in which the work platform 12 is in the shape of a dog bone (as illustrated in FIG. 1), the mid-portion 52 has a rectangular shape, with sides 54, 56 of the mid-portion 52 aligned parallel to the longitudinal axis L. The mid-portion 52 may have a width W_{M} ranging from about 12 inches to about 40 inches at its narrowest portion, as measured relative to the transverse axis T.

In this exemplary embodiment, each end-portion 60, 66 is formed of two contiguous convex portions, e.g., portions that are gibbous shaped (i.e., bulging outwardly away from a center portion of the work platform). The first end-portion 60 is formed of contiguous gibbous shaped portions 62, 64, and the second end-portion 66 is formed of contiguous gibbous shaped portions 68, 70. The construction and configuration of each end-portion 60, 66 with two gibbous shaped portions 62, 64 and 68, 70, respectively, gives the overall work platform 12 a dog-bone shaped outline.

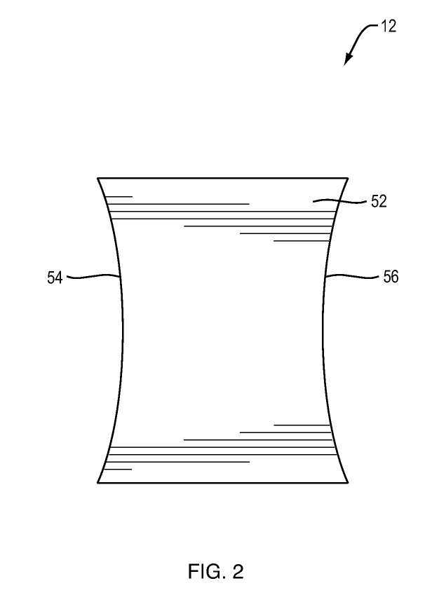

In other exemplary embodiments (as illustrated in FIG. 2), the mid-portion 52 may be formed of two curved sides 54, 56, for example, concave or arched inwardly along the longitudinal axis L toward a center portion of the work platform 12.

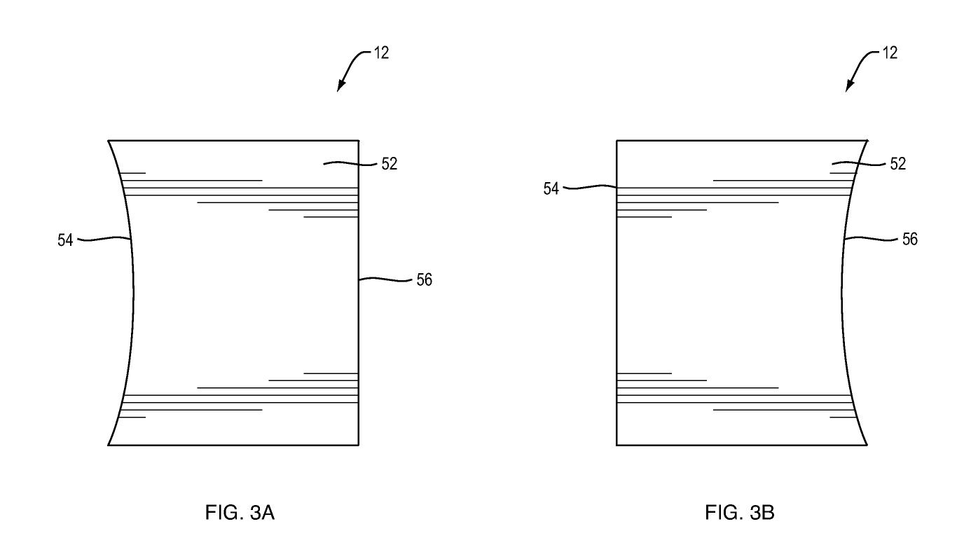

In other exemplary embodiments (as illustrated in FIGS. 3A and 3B), one of the sides 54, 56 of the mid-portion 52 may be straight and aligned parallel to the longitudinal axis L, and the other of the sides 54, 56 may be curved, for example, concave or arched inwardly along the longitudinal axis L toward a center portion of the work platform 12.

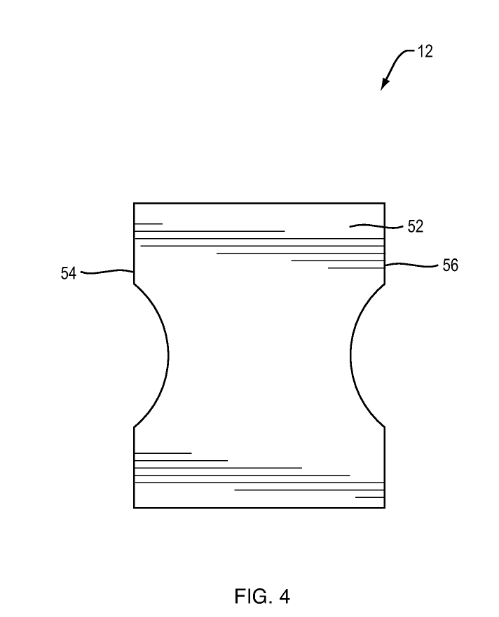

FIG. 4 illustrates yet another exemplary shape of the sides 54, 56 of the mid-portion 52, in which each side 54, 56 is configured as a straight portion with a radial cutout.

The work platform 12 includes an animal handler positioning area 58 adjacent to at least one side-wall 54, 56 of the mid-portion 52. A side-wall 54, 56 of the mid-portion 52, the first end-portion 60 and the second end-portion 66 may be configured to collectively define the animal handler positioning area 58 (shown as hashed areas in FIG. 1) at which an animal handler may conveniently position him/herself during a handling session. The animal handler positioning area 58 may be located immediately adjacent to the mid-portion 52, and may be formed by one or both of sides 54, 56 of the mid-portion 52.

The animal handler positioning area 58 may have a width W_{G} of about 15 inches to about 70 inches, measured relative to the transverse axis T between the side 54, 56 and the widest portion of the work platform 12 at which an animal handler can be accommodated during a handling session. In an exemplary embodiment, width W_{M} and width W_{G} are equal. In another exemplary embodiment, width W_{M} is about 1.5× wider than width W_{G}. In yet another exemplary embodiment, width W_{M} is about 2× wider than width W_{G}. In other exemplary embodiments, the ratio between width W_{M} and width W_{G} may vary between about 1 and about 2 in any small increments. In still another exemplary embodiment, width W_{G} is about 1.5× wider than width W_{M}. In another exemplary embodiment, width W_{G} is about 2× wider than width W_{M}. In other exemplary embodiments, the ratio between width W_{G} and width W_{M} may vary anywhere between about 1 and about 2 in any small increments.

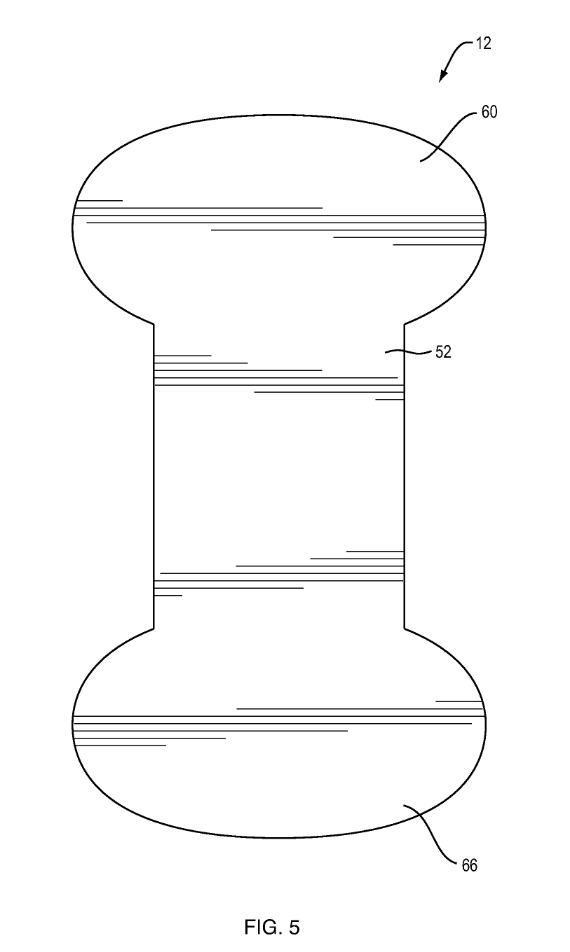

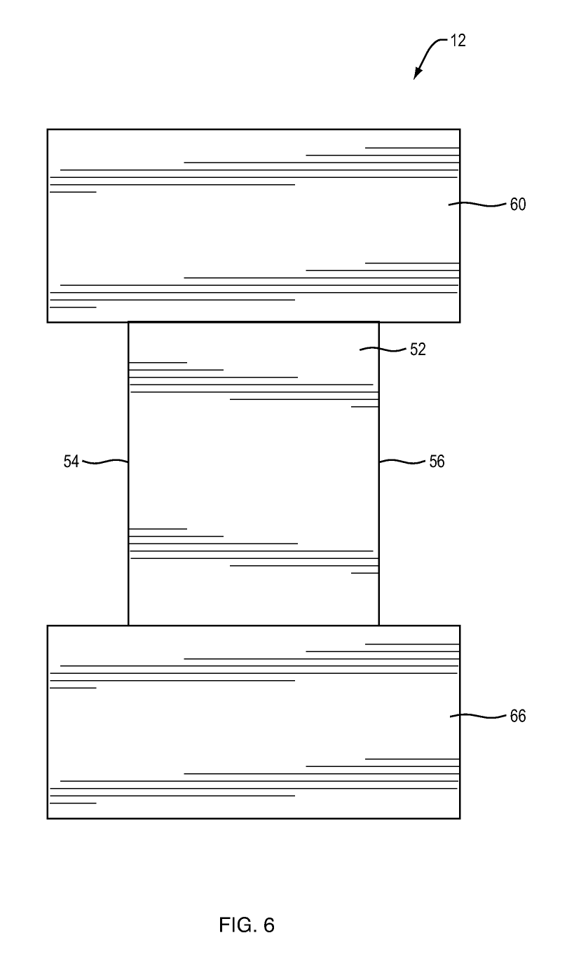

The end-portions 60, 66 of the work platform 12 may be configured to have various shapes irrespective of the shape of the mid-portion 52. In the exemplary embodiment of FIG. 1 in which the work platform 12 is in the shape of a dog bone, the end-portions 60, 66 are configured with gibbous shaped portions 62, 64, 68, and 70, in order to give the overall work platform 12 a dog-bone shaped outline. In another exemplary embodiment (as illustrated in FIG. 5), each end-portions 60, 66 is configured to have a partially elliptical shape. In another exemplary embodiment (as illustrated in FIG. 6), each end-portion 60, 66 is configured to have a rectangular shape.

Each end-portion 60, 66 may have a width W_{E} ranging between about 15 inches and about 100 inches at its widest portion, that is wider than the widest width W_{M} of the mid-portion 52. In an exemplary embodiment, width W_{E} is about 2.5× wider than width W_{M}. In another exemplary embodiment, width W_{E} is about 2× wider than width W_{M}. In yet another exemplary embodiment, width W_{E} is about 1.5× wider than width W_{M}. In other exemplary embodiments, the ratio between width W_{E} and width W_{M} may vary anywhere between about 1.5 and about 2.5 in any small increments.

The width of the mid-portion 52 relative to the width of one of the end-portions 60, 66 allows the animal handler to conveniently position him/herself at the narrower animal handler positioning area 58 and still access and use the wider end-portions 60, 66, e.g. by placing handling accessories at the end-portions 60, 66. In an exemplary embodiment, the two end-portions 60, 66 may have the same width W_{E} at their widest portions. In another exemplary embodiment, the two end-portions 60, 66 may have different widths W_{E} at their widest portions.

In an exemplary embodiment, the surface area of the planar surface formed by the mid-portion 52 is equal to the surface area of the planar surface formed by either of the end-portions 60, 66. In another exemplary embodiment, the surface area of the planar surface formed by the mid-portion 52 is about 1.5× larger than the surface area of the planar surface formed by either of the end-portions 60, 66. In yet another exemplary embodiment, the surface area of the planar surface formed by the mid-portion 52 is about 2× larger than the surface area of the planar surface formed by either of the end-portions 60, 66. In other exemplary embodiments, the ratio between the surface area of the planar surface formed by the mid-portion 52 and the surface area of the planar surface formed by either of the end-portions 60, 66 may vary anywhere between about 1 and about 2 in any small increments.

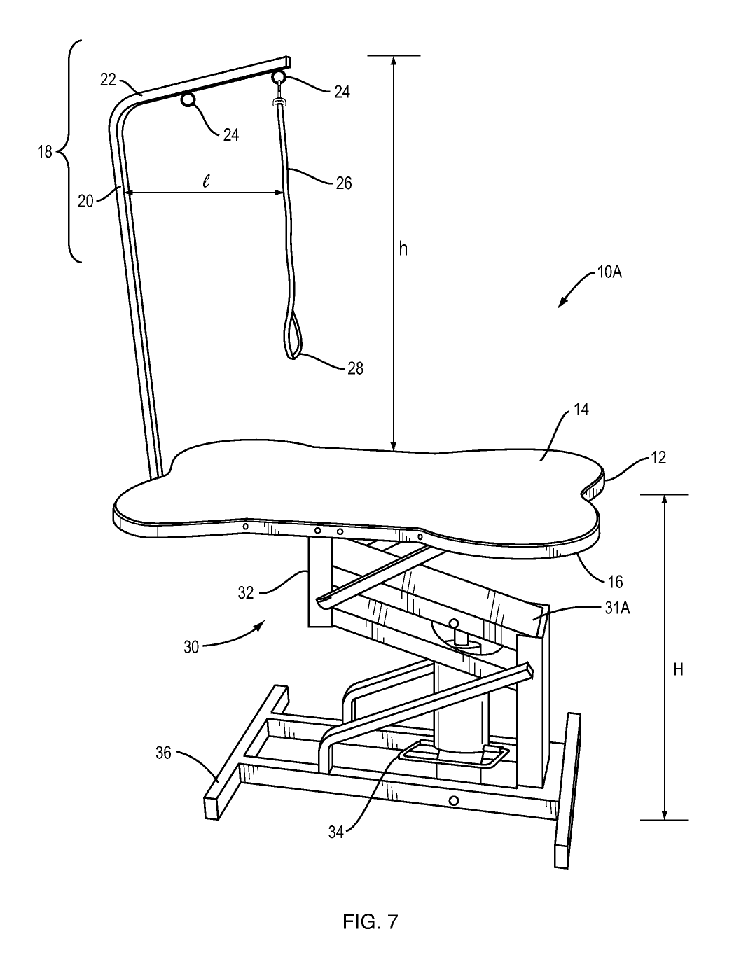

FIG. 7 illustrates a perspective view of an exemplary animal handling station 10A including the exemplary work platform 12 of FIG. 1. The handling station 10A includes the work platform 12 for supporting an animal during a handling session. The work platform 12 may be constructed of any number of materials including, but not limited to, aluminum, stainless steel, wood, wood composite, polymer, and similar materials. The length and width of the work platform 12 may be selected according to the size of the animal to be supported on the work platform or the physical location of the platform or both. In an exemplary embodiment, the edges of the work platform 12 may be raised to prevent dripping of fluid onto the floor or to prevent handling tools and accessories from falling off the work platform 12.

In an exemplary embodiment, illustrated in FIGS. 1 and 7, the work platform 12 is designed and configured in a dog-bone shaped outline. This particular shape provides ergonomic, functional, and operational advantages over conventional work platforms, which tend to be uniformly rectangular, circular or oval. In the exemplary embodiment, an animal handler positioned adjacent to the narrower mid-portion 52 of the dog-bone shaped work platform 12 is able to position him/herself close to the center of the work platform 12. This configuration allows the animal handler better control of the animal during a handling session and reduces the risk of the animal handler straining his/her back or suffering another injury while performing a handling function or operation on the animal. This configuration also allows the animal handler to gain better control of the animal. In addition, the slim outline presented by the dog-bone shape compels the animal to reduce its movement and remain centered on the work platform 12. The slim outline of the dog-bone shaped work platform 12 thus makes it more ergonomic and convenient to handle the animal and results in a more efficient handling session.

One top surface of the work platform 12, for example, a surface that contacts the paws of the animal, may be covered with a non-skid surface 14 to reduce the chance of the animal skidding on the work platform 12 during a handling session. The non-skid surface 14 may be composed of various materials including, but not limited to, rubber, vinyl, polyvinyl chloride (PVC), cloth, and similar materials. In an exemplary embodiment, the non-skid surface 14 may provide a cushioned surface for the animal's comfort during the handling session, allowing the animal to stand on the work platform 12 for a longer time. The side surfaces or edges of the work platform 12 may remain uncovered by the non-skid surface 14.

The bottom surface or underside of the work platform 12 may be equipped with one or more attachment mechanisms 16 configured to hold, hang, or otherwise secure tools and equipment used in handling the animal, e.g., an air blower for supplying a blast of air, a collection pail for collecting the animal's fur, tie-down straps to secure the animal, and similar animal handling equipment. An attachment mechanism 16 may include, but is not limited to, a hook, a sling, and similar engagement mechanisms. In an exemplary embodiment, each underside corner of the work platform 12 may be equipped with a hook.

The handling station 10A includes a handling arm 18 attached to the work platform 12 using an attachment device, e.g., clamps, screws, bolts, Velcro, snap-fit mechanisms and the like. The handling arm 18 and its components are provided to secure the animal on top of the work platform 12 during a handling session. In an exemplary embodiment, the handling arm 18 may be rotatably attached to the work platform 12 and may be rotated or swung in an arc up to 180°. Once rotated to a desired position, the handling arm 18 may be locked in place and prevented from rotating further using a locking mechanism. In another exemplary embodiment, the handling arm 18 may be fixed and non-movable. In another exemplary embodiment, the handling arm 18 may include two or more vertical arms with a cross-arm that extends across the vertical arms.

In an exemplary embodiment, the handling arm 18 may include a vertical portion 20 and a horizontal portion 22. The vertical and horizontal portions may be separate and attachable to each other or formed in one continuous piece. The height h of the arm 18 may be adjusted to more conveniently secure animals of different sizes, e.g., the height may be increased to secure a taller animal, and decreased to secure a shorter animal. In an exemplary embodiment, the height h may be adjusted between about 15 inches and about 65 inches. The length of the vertical portion 20 of the arm 18 may be adjustable, so that the height h of the arm 18 can be adjusted by adjusting the length of the vertical portion 20. In an exemplary embodiment, the vertical portion 20 may be foldable and/or telescoping, in which the length of the vertical portion 20 may be adjusted by telescoping the vertical portion 20 along its axis.

The length l of the arm 18 may be adjusted to secure an animal at a convenient location on the work platform 12, e.g., the length may be increased to secure an animal near the mid-portion of the work platform 12, and may be decreased to secure an animal nearer to the handling arm 18. The length of the horizontal portion 22 of the arm 18 may be adjustable, so that the length l of the arm 18 can be adjusted by adjusting the length of the horizontal portion 22. In an exemplary embodiment, the horizontal portion 22 may be foldable and/or telescoping, in which the length of the horizontal portion 22 may be adjusted by telescoping the horizontal portion 22 along its axis. In an exemplary embodiment, the length l of the arm 18 may be adjusted between about 15 inches and about 100 inches.

The horizontal portion 22 of the handling arm 18 may be equipped with one or more attachment mechanisms 24 disposed along its length. An exemplary attachment mechanism 24 may be a hook. One end of a handling cord 26 may be removably connected to the attachment mechanism 24 using a buckle, a snap, a clasp, and similar attachment mechanisms. The handling cord 26 may be composed of various materials including, but not limited to, nylon, cotton, rubber, and similar materials. The handling cord 26 may be equipped with a length adjustment mechanism, e.g., a plastic slider, that allows the animal handler to adjust the length of the handling cord 26 based on the height of the animal. An exemplary handling cord 26 may range from about 7 inches to about 45 inches in length.

The other end of the handling cord 26 may be connected to a handling loop 28, such that the handling cord 26 and the handling loop 28 hang from the attachment mechanism 24. During a handling session, the head of the animal is positioned through and secured by the handling loop 28. The handling cord 26 may be removably connected to the handling loop 28 using a releasable attachment device including, but not limited to, a buckle, a snap, a clasp, and similar attachment devices. The handling loop 28 may be composed of various materials including, but not limited to, nylon, cotton, rubber, and similar materials. The handling loop 28 may be equipped with a length adjustment mechanism, e.g., a plastic slider, that allows the animal handler to adjust the circumference of the handling loop 28 based on the size of the animal's head. An exemplary handling loop 28 may have a circumference ranging from about 5 inches to about 35 inches.

In an exemplary embodiment, the underside of the work platform 12 may be rotatably coupled to a base unit 30 that is placed beneath the work platform 12 to support the work platform and to optionally lift/lower the work platform. The work platform 12 may be allowed to rotate in an arc up to 360° at its connection point with the base unit 30. This ability to rotate the work platform 12 reduces the need to move around the handling station 10 or reposition the animal on the work platform 12 during a handling session.

In some exemplary embodiments, the base unit 30 is configured as a lift mechanism 31 with an adjustable height that supports, lifts and lowers the work platform 12. In some instances, a handling session may begin when the work platform 12 is lowered by the lift mechanism 31 so that it is a short distance above the ground. The lowering of the work platform 12 allows an animal to climb onto the work platform 12 with little assistance and, in some instances, without assistance. Once the animal is secured on the work platform 12, the lift mechanism 31 is used to elevate the work platform 12 to a greater height H above the ground. This elevation brings the animal to a work level for the animal handler who may be standing or sitting on a chair. The height to which the work platform 12 is elevated may be selected based on a number of factors including, but not limited to, the height of the animal, the height of the animal handler, whether the animal is standing or sitting, whether the animal handler is standing or sitting, and similar other factors. The elevated height of the work platform 12 may be adjusted up or down using the lift mechanism 31 during a handling session and/or between handling sessions. Once elevated to a desired height, the lift mechanism 31 may be locked in place using a locking mechanism. The lift mechanism 31 may optionally be placed on casters (not pictured) to allow the animal handler to easily move the handling station 10A.

The lift mechanism 31 of an exemplary animal handling station may include, but is not limited to, a hydraulic lift, an electric lift, and similar other lift mechanisms. FIG. 7 illustrates an exemplary animal handling station 10A in which the base unit 30 employs a hydraulic lift 31A. The hydraulic lift 31A may be coupled to a link mechanism 32 connected to the work platform 12 that cooperatively interact to lift and lower the work platform 12. The hydraulic lift 31A may include a hydraulic pump operable by the animal handler to actuate the link mechanism 32 and thereby raise or lower the work platform 12. The base unit 30 may include a foot pump 34 with a brake to allow a user to operate the hydraulic pump 31A. The hydraulic lift 31A may be equipped with leveling legs 36 for stability and for securely gripping the work platform 12.

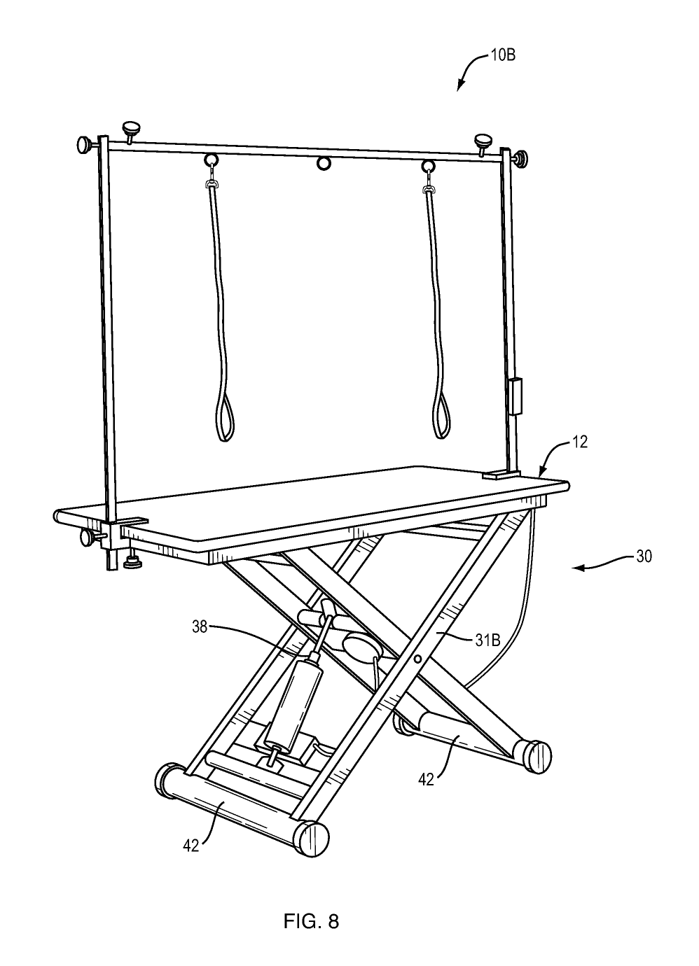

FIG. 8 illustrates another exemplary handling station 10B in which the base unit 30 employs an electric lift 31B. The electric lift 31B may include an electric actuator column 38 connected to the work platform 12 that lifts and lowers the work platform 12. The electric lift 31B may include a motor that drives the electric actuator column 38, and a switch operable by the animal handler to turn the motor on or off, e.g., a foot switch 40. The motor may be driven to raise or lower the electric actuator column 38, which then lifts or lowers the work platform 12. The electric lift 31B may be equipped with leveling legs 42 for stability and for securely gripping the work platform 12.

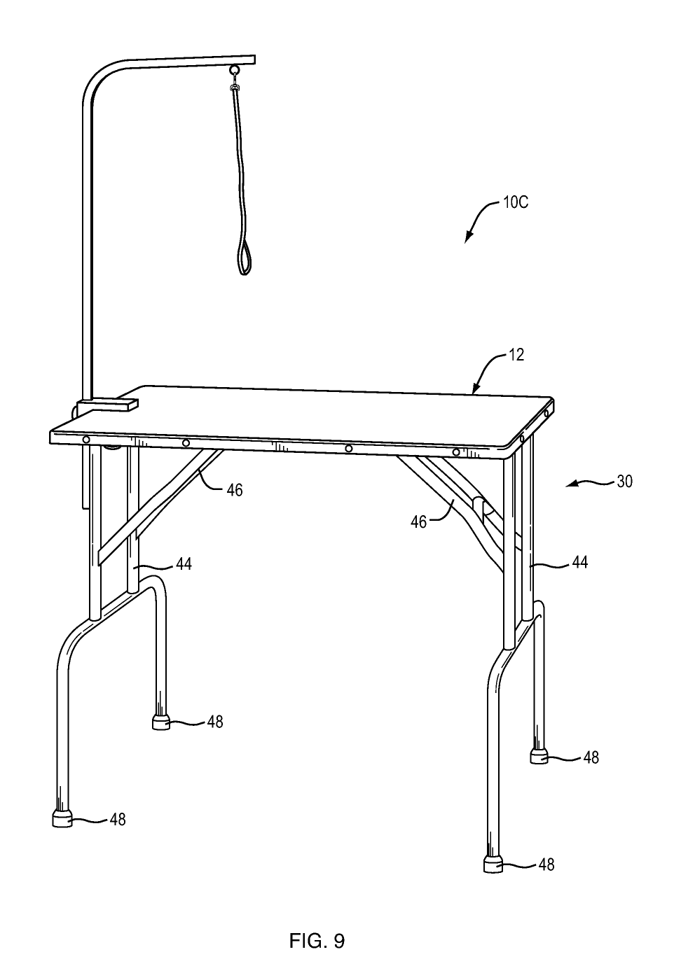

In some exemplary embodiments, the base unit 30 is configured as a stationary support with a fixed height that supports the work platform 12 but does not adjust the height of the work platform, e.g., a support column, a set of legs, and similar support structures with a fixed height. FIG. 9 illustrates an exemplary handling station 10C in which the base unit 30 employs a set of folding legs 44. The folding legs 44 support the work platform 12 during a handling session, but do not allow height adjustment of the work platform 12. The base unit 30 may also include one or more support brackets 46 for extra stability. The bottom ends of the folding legs 44 may each be fitted with a rubber cap 48 for stability and to securely position the handling station 10C.

One of ordinary skill in the art will appreciate that the present invention is not limited to the specific exemplary embodiments described herein. Many alterations and modifications may be made by those having ordinary skill in the art without departing from the spirit and scope of the invention. Therefore, it must be expressly understood that the illustrated embodiments have been shown only for the purposes of example and should not be taken as limiting the invention, which is defined by the following claims. These claims are to be read as including what they set forth literally and also those equivalent elements which are insubstantially different, even though not identical in other respects to what is shown and described in the above illustrations.

What is claimed is:

1. An animal handling work platform configured to support an animal, the animal handling work platform comprising:
a first end portion having a first width (W₁);
a second end portion having a second width (W₂); and
a middle portion having a third width (W₃) disposed contiguously between the first and second end portions to form a planar surface;
wherein a side of the middle portion, the first end portion and the second end portion collectively define an animal handler positioning area, the animal handler positioning area defined by a W₃:W₁ ratio of about 1:2 and a W₃:W₂ ratio of about 1:2 to allow an animal handler to be adjacent to an animal supported on the work platform.

2. The animal handling work platform of claim 1, wherein the middle portion has first and second sides that are straight and aligned parallel to a longitudinal axis of the work platform.

3. The animal handling work platform of claim 1, wherein the middle portion has first and second sides that are concave in shape.

4. The animal handling work platform of claim 1, wherein the first end portion includes a first convex portion and a second convex portion, the first and second convex portions disposed contiguous to each other.

5. The animal handling work platform of claim 1, further including:
a base unit coupled to an underside of the middle portion to support the work platform.

6. The animal handling work platform of claim 5, wherein the base unit is height-adjustable.

7. The animal handling work platform of claim 6, wherein the base unit includes a hydraulic lift mechanism or an electric lift mechanism.

8. The animal handling work platform of claim 5, wherein the height of the base unit is fixed.

9. The animal handling work platform of claim 8, wherein the base unit includes a set of foldable legs.

10. The animal handling work platform of claim 1, wherein W₁ is measured at a widest section of the first end portion, and W₂ is measured at the widest section of the second end portion.

11. An animal handling work platform configured to support an animal, the work platform comprising:
a first end portion having a first width (W₁) and including first and second convex portions that are contiguous to each other;
a second end portion having a second width (W₂) and including third and fourth convex portions that are contiguous to each other; and
a middle portion disposed contiguously between the first and second end portions to form a planar surface, the middle portion having a rectangular shape and a third width (W₃), the middle portion including first and second sides disposed parallel to each other and parallel to the longitudinal axis;
wherein W₃ is smaller than W₁ and W₂; and
wherein the first and second sides of the middle portion, the first and second convex portions of the first end portion, and the third and fourth convex portions of the second end portion are configured to create a dog-bone shaped outline.

12. The animal handling work platform of claim 11, wherein the middle portion has first and second sides that are straight and aligned parallel to a longitudinal axis of the work platform.

13. The animal handling work platform of claim 11, wherein the middle portion has first and second sides that are concave in shape.

14. The animal handling work platform of claim 11, wherein the first end portion includes a first convex portion and a second convex portion, the first and second convex portions disposed contiguous to each other.

15. The animal handling work platform of claim 11, further including:
a base unit coupled to an underside of the middle portion to support the work platform.

16. The animal handling work platform of claim 15, wherein the base unit is height-adjustable.

17. The animal handling work platform of claim 16, wherein the base unit includes a hydraulic lift mechanism or an electric lift mechanism.

18. The animal handling work platform of claim 15, wherein the base unit is fixed at a selected height.

19. The animal handling work platform of claim 18, wherein the base unit includes a set of foldable legs.

20. The animal handling work platform of claim 11, wherein the first side of the middle portion, the first end portion and the second end portion collectively define an animal handler positioning area, the animal handler positioning area defined by a W₃:W₁ ratio of about 1:2 and a W₃:W₂ ratio of about 1:2.

21. An animal handling work platform configured to support an animal, the animal handling work platform comprising:
a first end portion having a first width (W₁);
a second end portion having a second width (W₂); and
a middle portion having a third width (W₃) disposed contiguously between the first and second end portions to form a planar surface;
wherein a side of the middle portion, the first end portion and the second end portion collectively define an animal handler positioning area that allows an animal handler to be adjacent to an animal supported on the work platform.
